(19) United States
(12) Patent Application Publication
(10) Pub. No.: US 2013/0254713 A1
(43) Pub. Date: Sep. 26, 2013

(54) Sourcing and Work Product Techniques

(71) Applicant: ADOBE SYSTEMS INCORPORATED, San Jose, CA (US)

(72) Inventors: Scott K. Belsky, New York, NY (US); William H. Allen, New York, NY (US)

(73) Assignee: ADOBE SYSTEMS INCORPORATED, San Jose, CA (US)

(21) Appl. No.: 13/829,032

(22) Filed: Mar. 14, 2013

Related U.S. Application Data
(60) Provisional application No. 61/615,509, filed on Mar. 26, 2012.

(51) Int. Cl. G06F 3/0482

(52) U.S. Cl. CPC G06F 3/0482
USPC 715/810

(57) ABSTRACT

Sourcing and work product techniques are described. In one or more implementations, a system includes one or more modules implemented at least partially in hardware and that are configured to collect data related to an opportunity described in a posting. The data is collected via an application made by a user to the posting, a recommendation made on behalf of another user based on the posting, and at least one discovery made via a search. The system also includes at least one module implemented at least partially in hardware and configured to generate a user interface that includes representations of users from the data and a portion that is configured to display potential candidates responsive to one or more selections made via the user interface of one or more of the representations.

### RELATED APPLICATIONS

This application claim priority under 35 U.S.C. Section 119(e) to U.S. Provisional Patent Application No. 61/615,509, filed Mar. 26, 2012, and titled “Talent Sourcing,” the entire disclosure of which is hereby incorporated by reference.

### BACKGROUND

Talent sourcing has been an issue ever since the first time one person looked for another person to assist in a project. This issue was originally solved via “word of mouth” and subsequently expanded into postings to which people applied that were interested in the opportunity described in the posting, such as for a job opportunity, to work on a project, and so on.

However, information obtained using these conventional techniques at times was tangentially related to the posting. For example, although a person could detail an educational and employment history it could be difficult to determine how much of this history relates to the opportunity at hand. Consequently, these conventional techniques could make it difficult to compare applicants and force reliance on a “best guess” regarding the expertise of the applicants.

### SUMMARY

Sourcing and work product techniques are described. In one or more implementations, a system includes one or more modules implemented at least partially in hardware and that are configured to collect data related to an opportunity described in a posting. The data is collected via an application made by a user to the posting, a recommendation made on behalf of another user based on the posting, and at least one discovery made via a search. The system also includes at least one module implemented at least partially in hardware and configured to generate a user interface that includes representations of users from the data and a portion that is configured to display potential candidates responsive to one or more selections made via the user interface of one or more of the representations.

In one or more implementations, a user's interaction is monitored with functions of an application to generate one or more items of work product, the functions performed as part of execution of the application. Metadata is exposed that references this monitored user interaction as being associated with the user or respective ones of the one or more items of work product, the exposed metadata configured to support a search to locate the user or the respective ones of the one or more items of work product based on the functionality with which the user interacted.

In one or more implementations, a user interface is generated that has a plurality of examples of work product produced by respective ones of a plurality of users. One or more selections are received via the user interface of one or more of the examples, the one or more selections indicating a user associated with a respective said example is a potential candidate for an opportunity. The one or more selections are aggregated as a collection of potential candidates for the opportunity.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a system in an example implementation in which a user interface is output that is populated using sourcing data.

FIG. 3 depicts a system in an example implementation in which a sourcing manager module is shown in greater detail as including functionality to create posts and manage sourcing data.

FIG. 4 depicts a system in an example implementation in which metadata describing expertise of a user is collected and used as part of a sourcing process.

FIG. 5 depicts an example of a user interface that is configured to output representations of work product as a basis to determine potential candidates for an opportunity.

FIG. 6 is a flow diagram depicting a procedure in an example implementation in which data is collected from three sources for output in a user interface configured to support selection of potential candidates.

FIG. 7 is a flow diagram depicting a procedure in an example implementation in which work product is leveraged to select potential candidates for an opportunity.

FIG. 8 is a flow diagram depicting a procedure in an example implementation in which metadata is generated that described a user's interaction with particular functions of an application.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

Sourcing and posts may be used in the pursuit of potential candidates for an opportunity, such as to work on a project, an employment opportunity, and so on. However, conventional techniques often failed to provide sufficient insight into the candidates, thereby making it difficult to differentiate between the candidates as well as to locate a candidate with expertise in a desired area.

Accordingly, sourcing and work product techniques are described. These techniques may be leveraged in a variety of ways and employ a variety of different functionality to support efficient sourcing and insight into potential candidates for an opportunity. For example, techniques are described in which data may be collected from a variety of different sources such that a user may locate a potential candidate. These sources may include applications made to a posting, recommendations made by one user on behalf of another user, recommendations that were automatically generated based on the posting, discoveries made by the user who generated the posting, and so on. Data representing these users may then be output for display in a user interface as profiles in a unified manner such that data from the different sources is displayed together.

Selections may then be made from these users to indicate the selected users as potential candidates for the opportunity, such as via a drag-and-drop operation using a cursor control device, a gesture, and so on. The potential candidates may be included in a separate portion of the user interface that is displayed concurrently with the data such that continued selections may be made and yet a user is kept up-to-date regarding which selections were made, a number of the selections, and so on.

Further, updates to the data may be provided even after selection of the potential candidates. For example, a selection may be made based on viewing work product of a user, expertise of a user with a particular application, and so on. As changes are made to the work product (e.g., creation of additional images), these changes may be provided as updates in the user interface. Thus, the collection of candidates and data associated with those candidates may also be kept up-to-date. Further, by viewing work product and gaining information regarding expertise with applications that may be used to generate the work product, the user may also make an informed decision regarding the potential candidates. Further discussion of these and other features may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

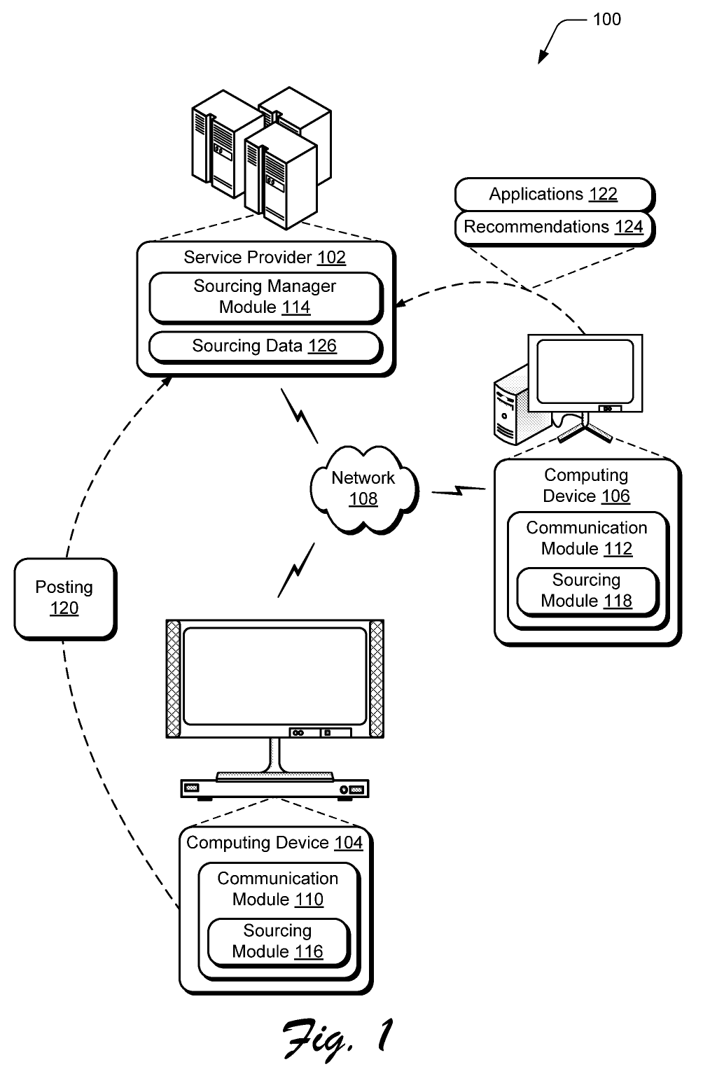

FIG. 1 is an illustration of an environment 100 in an example implementation that is operable to employ techniques described herein. The illustrated environment 100 includes a service provider 102 and a plurality of computing devices 104, 106 that are communicatively coupled via a network 108. The service provider 102 and the computing device 104, 106 may be implemented in a variety of ways.

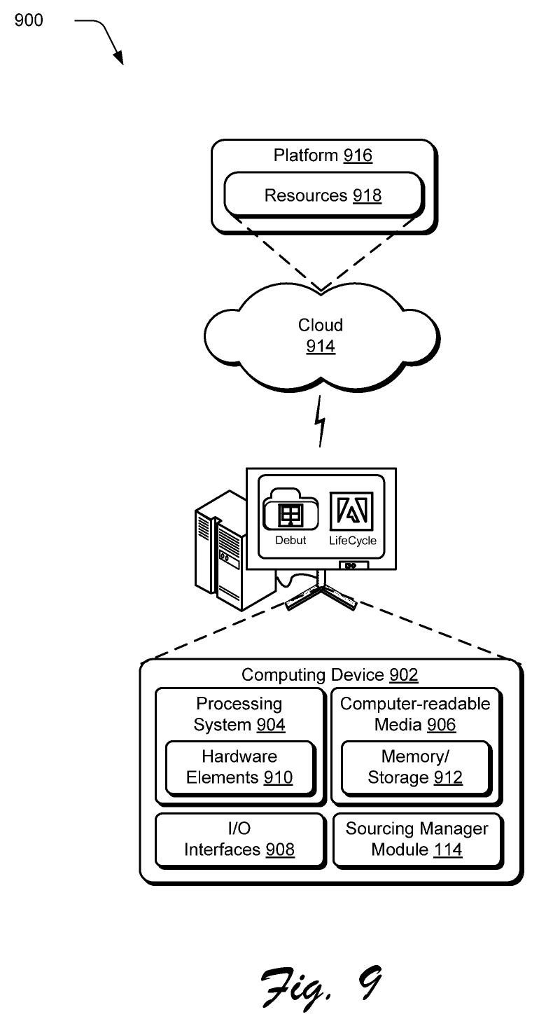

The computing devices 104, 106 for instance, may be configured as a desktop computer, a laptop computer, a mobile device (e.g., assuming a handheld configuration such as a tablet or mobile phone), and so forth. Thus, the computing devices 104, 106 may range from full resource devices with substantial memory and processor resources (e.g., personal computers, game consoles) to a low-resource device with limited memory and/or processing resources (e.g., mobile devices). Likewise, the service provider 102 may be implemented in a variety of different ways, such as via a computing device, multiple servers utilized by a business to perform operations “over the cloud” as further described in relation to FIG. 9, and so on.

The computing devices 104, 106 are each illustrated as including a respective communication module 110, 112. The communication modules 110, 112 are representative of functionality to communicate via the network 108, such as with each other, with the service provider 102, and so on. An example of functionality that may be used to communicate via the network 108 is represented by a sourcing manager module 114 of the service provider 102 and sourcing modules 116, 118 of the respective computing devices 104, 106. These modules are representative of functionality configured to implement sourcing and work product techniques described herein.

The techniques may be implemented in a variety of ways. For example, the techniques may be implemented by the sourcing manager module 114 as a web-based application that uses one or more web servers to receive requests via the network 108 from the computing devices 104, 106 as well as to send responses to the requests. In another example, this functionality may be implemented using a distributed architecture that employs the sourcing manager module 114 of the service provider 102 as well as the sourcing modules 116, 118 of the computing devices 104, 106.

Regardless of how implemented, the sourcing and work product techniques described herein may be utilized to support a wide range of functionality. For example, a user of computing device 104 may interact with the sourcing manager module 114 directly via the network 108 or indirectly via the source module 116 to specify a posting 120 for an opportunity, such as to participate in a particular project, an employment opportunity, and so on.

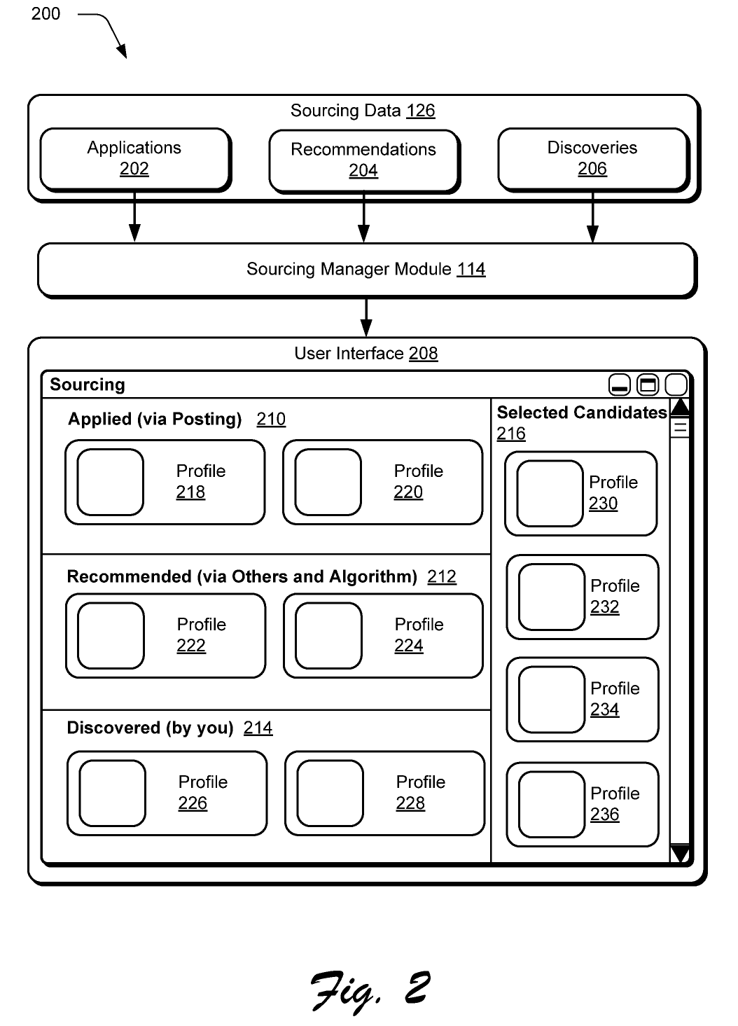

This posting 120 may then be exposed by the service provider 102 via the network 108 to receive applications 122 from a user, recommendations 124 on behalf of a user from another user, and so on. The posting 120 may also be used to generate recommendations automatically and without user intervention as further described in relation to FIG. 2. Other sources are also contemplated, such as through discoveries made by a user of the computing device 104 by browsing profiles. These profiles may then be saved as sourcing data 126 for output in a user interface, an example of which is described as follows and shown in a corresponding figure.

FIG. 2 depicts a system 200 in an example implementation of a system 200 in which a user interface is output that is populated using the sourcing data 126. As previously described, sourcing data 126 may originate from a variety of different sources, such as applications 202, recommendations 204, and discoveries 206. As such, the sourcing data may include information about candidates, profiles of candidates, talent searches, recommendations, and the like.

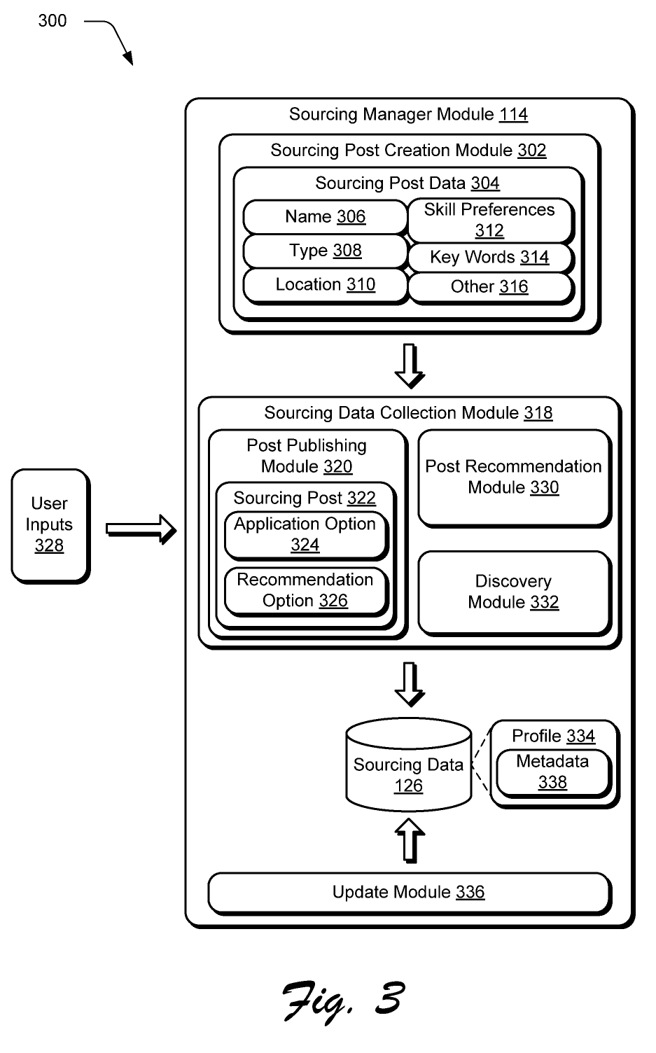

For example, applications 202 may be received in response to a posting 120 that is exposed online that solicits applications from candidates. These job postings could be posted on sites like Behance®, Facebook®, LinkedIn®, Monster® websites, or any other site that hosts postings. Recommendations 204 are referrals of a candidate from another person. These recommendations 204 may be made, for instance, by a user who viewed the job posting or has otherwise been made aware of the posting. Recommendations 204 may also be made automatically as further described in relation to FIG. 3. Discoveries 206 relate to candidates found by the user, such as to browse profiles by a user of computing device 104 that are saved as part of the sourcing data 126 from a user of computing device 106. Other examples are also contemplated, such as to locate a candidate's web page or online social networking profile. A candidate's web page can be any personal website on the web. Social networking profiles would be on networks such as LinkedIn®, Facebook®, Behance® networks, or others. This data may also be saved as part of the sourcing data 126.

The sourcing data 126 may then be aggregated by the sourcing manager module 114 into a user interface 208. In this way, the results from these different sources may be displayed in a single view. In the illustrated example, the user interface 208 includes four portions, an applied 210 portion, a recommended 212 portion, a discovered 214 portion, and a selected candidates 216 portion. The applied 210 portion includes profiles 218, 220 that were obtained as applications 202 as described above. The recommended portion 212 includes profiles 222, 224 that were obtained as recommendations 204 and the discovered portion 214 includes profiles 226, 228 obtained as discoveries 206. Thus, the user interface 208 includes profiles obtained from each of the three sources in a single view in the user interface 208.

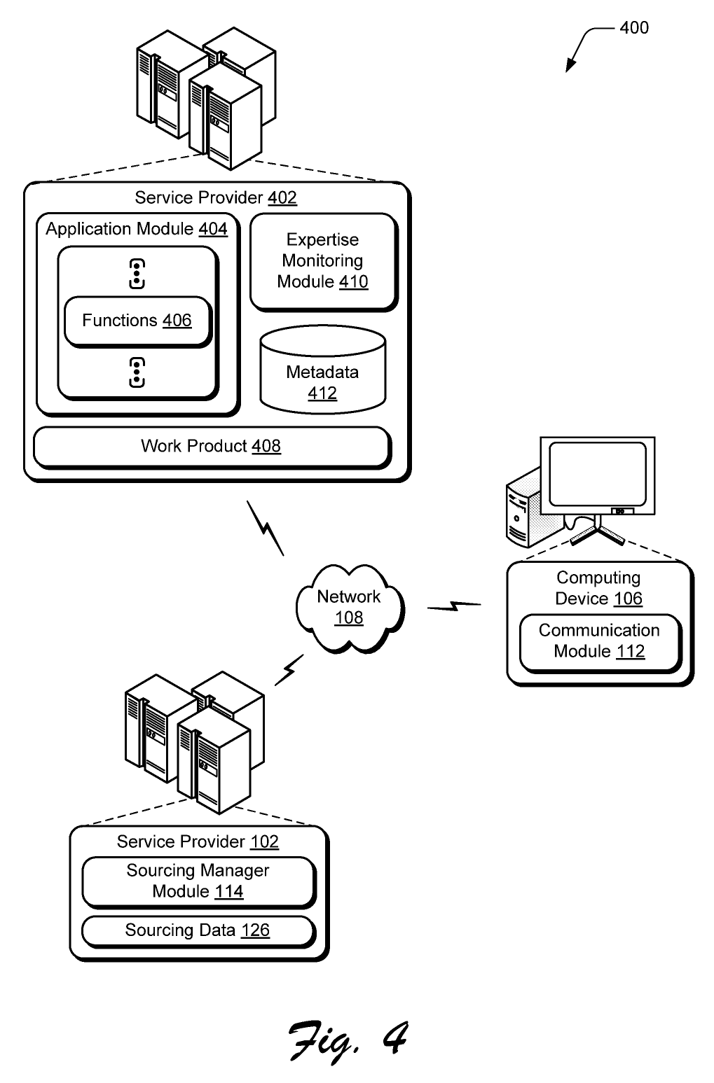

The profiles 218-236 may be configured in a variety of different ways. For example, the profiles may include information that is representative of a user's identity, such as name, picture, and so on. The profile may also include information that is representative of a user's work product, such as images created by the user, sound samples, images of objects created the user, and so on. Further discussion of work product of a user. In a further example, the profiles may indicate expertise attributed to the user based on generation of work product. Further discussion of work product, expertise, and metadata may be found beginning in relation to FIG. 4.

The user interface 208 also includes a selected candidates portion 216. This portion includes profiles 230, 232, 234, 236 that are selected as potential candidates from the other portions of the user interface 208. This may be performed in a variety of ways, such as through use of a cursor control device, gesture, keyboard, voice command, and so on. Thus, in this example the user interface 208 may be configured to keep a user informed as to which profiles were indicated as selected candidates while continuing selection through navigation of profiles in the other portions. The profiles of the selected candidates 216 may also be updated as described in greater detail in the following discussion and shown in the corresponding figure.

FIG. 3 depicts a system 300 in an example implementation in which the sourcing module 114 is shown in greater detail as including functionality to create posts and manage sourcing data 126. The sourcing manager module 114 is illustrated as including a sourcing post creation module 302. The sourcing post creation module 302 is representative of functionality to generate sourcing post data 304 that is to be used to create a post for an opportunity. For example, a user interface may be output via which a user may specify a name 306, type 308 (e.g., job title), location 310 for the opportunity, skill preferences 312, key words 314, and other 316 criteria.

The sourcing post data 304 may then be used by a sourcing data collection module 318 to collect sourcing data 126 relating to the post. For example, a post publishing module 320 may be employed to expose a sourcing post 322, such as an online job posting that is published on a website. The sourcing post 322, for instance, may include an application option 324 and a recommendation option 326. The application option 324 may receive user inputs 328 from a user that wishes to apply to the sourcing post 322.

The recommendation option 326 may be used to receive use inputs 328 from one user to recommend another user. Data may be collected as part of this recommendation in a variety of ways, such as via the user inputs 328 as well as leveraging the user inputs 328, e.g., to locate additional data about the referred user, such as from a social network, and so on. This may be performed by leveraging the post recommendation module 320 which may perform this search automatically and without user intervention. Additionally, the post recommendation module 320 may leverage the sourcing post data 304 to make recommendations itself without selection of the recommendation option 326 in the sourcing post 322.

Thus, recommendations may be generated in a variety of ways. This may happen as a referral from someone in a user's network on the website/system, or from another candidate on the system. For example, any user who sees the “Sourcing Post” 322 on a participating website that results from the sourcing post data 304 can click the recommendation option 326 and then reference people that are believed to be suitable for the opportunity. Those who are referred as candidates automatically show up in an “All Candidates” view under the “Recommended” category, along with the NAME of the user that referred them. Information may also be automatically pulled from the referred candidate's profile.

The post recommendation module 330 may also employ algorithms to make recommendations that may be performed automatically and without user intervention. Those who are recommended as candidates by the post recommendation module 330 may also automatically show up in an “All Candidates” view under the “Recommended” portion of the user interface, along with a notation that explains that the algorithm automatically recommended them. The algorithm, for instance, may search for criteria related to the sourcing post data 304, including, but not limited to, location 310, availability for work, fields of expertise and skill proficiency (e.g., specified manually by a user or automatically through monitored interaction as further described in relation to FIG. 4), friends-in-common, years of experience, and so on. Other examples are also contemplated without departing from the spirit and scope thereof.

The sourcing data collection module 318 is also illustrated as including a discovery module 332. The discovery module 332 is representative of functionality to assist an originator of the sourcing post data 304 to also search for sourcing data 126. For example, these profiles may be manually selected by the user. Users, such as recruiters, can search the Internet and click a button (either a plug-in on their browser, or an “ADD AS CANDIDATE” button displayed on participating sites) to manually add a person as a candidate as part of sourcing data that is associated with a particular post. Candidates can be added from any web page on the web, from social network profiles on other social networks, or from our own database of candidates. An online application, browser plug-in, and so on may be configured to allow a user to “ADD AS CANDIDATE” anyone the user come across to an active search that is currently running.

In another example, a browser plug-in or other functionality may support use of an “ADD AS CANDIDATE” button on anyone's profile. Selection of “ADD AS CANDIDATE” may prompt the user to designate this person's profile as a candidate for current sourcing. The ability to ADD AS CANDIDATE any webpage or profile the user comes across online (via a browser plug-in OR an “ADD AS CANDIDATE” button on a user's profile) may be used to pull in the user's information from the page or other database and fill a profile 334 that is to be displayed along with other candidates in the user interface 208.

When a user is manually added as a candidate to an active talent search, this user's candidate profile 334 may be automatically generated if it doesn't already exist on the system. This profile, like the others, is displayed in the user interface 208 under the discovered 214 portion, along with a notion that explains that a user, such as the recruiter (e.g., labeled as “Discovered by You”), discovered this person at [particular website] on [particular date/time]. As described herein, the sourcing manager module 114 aggregates all profiles that are sourced via applications 202, recommendations 204, and discoveries 206 in a single centralized place for representing the results in a single view. For example, every profile, regardless of how they were sourced in the above three methods, has a representation that includes name, how sourced (e.g., applied via a job posting, recommended/referred, or discovered by you) as well as other information that is either taken from their online website, is provided by the candidate himself or the person recommending them, or that already exists in the database. The profiles that are displayed may be generated from queries to the database, calling up information sourced as explained above.

In the depicted embodiment, the sourcing manager module 114 allows profiles to be saved and aggregated. For example, the following are examples of profiles from the different sources:

Name of Talent Search, Created by User
Applied (via Job Posting)
   Profile A (Card View)
   Profile B (Card View)
Recommended (via Others & Algorithm)
   Profile C (Card View)
   Profile D (Card View)
Discovered (by you)
   Profile E (Card View)
   Profile F (Card View)
      The sources may also include referrals, such as from other users, a referral service, algorithm, and so on.

In the depicted embodiment of FIG. 2, the user interface is configured to allow a user to select postings as potential candidates, e.g., “star” the profiles. For example, the following list could include the card profiles of the starred candidates:
Starred: [Name of Talent Search]
   Profile A (Card View)
   Profile D (Card View)
   Profile F (Card View)

Thus, a search for users for an opportunity may begin by receiving input from a user to create search, an example of which is described as a “talent search” below. For example, processing logic of the sourcing manager module 114 may be used to generate a user interface in which the user can login, provide a name or the talent search, the type of talent (e.g., designating full-time, part-time, internship, or freelance). The user may also specify location preferences, skill preferences as further described beginning in relation to FIG. 4, or other keywords for candidates.

A posting may then be created in response to user input. Also, the processing logic provides an option for the user to skip this step. For example, a user can create a job posting, including a title for the job position, a description for the job. In another embodiment, the processing logic can use some applicant preferences that are prefilled from the talent search, such as type, locations, skills, or other keywords. In an implementation, the job posting is created automatically when a “Talent Search” is created, if the user wants to post one. There is also the option to conduct a talent search without posting a job posting, thereby using source of new candidates to as recommended by the post recommendation module 330 or discovered using the discovery module 332.

The processing logic begins to source candidates for the user, including (1) getting applicants, (2) getting recommendations; and (3) discovering candidates. For (1), the processing logic may distribute the positing on various job boards, such as on different websites around the web. Any prospective candidate can apply to the posting, submit relevant information, e.g., whether manual entry of information, uploading their resume, or “syncing” with an existing social network profile—or scraping their personal website. The job positing may include the job title, job description, and may include buttons to apply or to recommend. A candidate or recommending person can submit application information manually, or upload a resume, can synchronize their social network profile to pull relevant info into application, or can enter their personal website URL, and their application information can be pulled from the website. These submissions are considered the sources for the applications 202, and a profile for the candidate can be created automatically and without user intervention.

For (2), the processing logic can get recommendations of candidates. For example, anyone who sees the job posting can also “recommend” another person as a candidate for the job. When making the recommendation, relevant information may be submitted, whether manual entry of information, or “sync” with an existing social network profile—or entering URL and scraping the personal website. For example, a person can submit another person's application info manually, synchronize with that person's social network profile to pull relevant info into application, or synchronize with that person's social network profile to pull relevant info into application. These submissions are considered the sources for the recommendations 204, and a profile for the candidate can be created automatically and without user intervention.

For (3), the processing logic can discover candidates through implementation as the discovery module 332. For example, a recruiter may view any social network profile or website that represents a person, and can select “ADD AS CANDIDATE,” as a browser extension or an embedded button on the profile. The online profile or website, for instance, may include the name of the candidates, social network profile data, resume data, or a personal website for the candidate. The recruiter can select the person for addition as a prospective candidate. These submissions may be considered the DISCOVERED (by you) sources, and a profile for the candidate can be created automatically and without user intervention as before.

In an implementation, the “ADD AS CANDIDATE” button is displayed on candidate profiles of any partnering websites. For example, Facebook® or About.me®, or some other site may opt to provide an option for their users to place the “ADD AS CANDIDATE” button on their portfolio pages. Similarly, a button can be placed on all of the profiles and websites associated with the talent search mechanism 120, such as those provided by Behance®.

The “ADD AS CANDIDATE” functionality may also be implemented as a plug-in in a browser that would allow a user to add other profiles on non-supported websites as candidates to a user's active talent searches. When a user does this, the sourcing functionality of the sourcing manager module 114 may gather information from the web page to complete the candidate profile and may prompt the user to supply some of this info as well if not available to the module. Alternatively, the “ADD AS CANDIDATE” could be implemented using other mechanisms as would be appreciated by one of ordinary skill in the art having the benefit of this disclosure.

As stated above, the processing logic can create candidate profiles, such as a card view of the candidates as shown in FIG. 2. The card view may include the candidate's name and data relating to past work experience, and other resume/portfolio information. The processing logic presents a single view with the profiles of the candidates from the three sources. The candidate profiles can be displayed under three separate headers of respective portions, e.g., applied, recommended, discovered. The user can select the candidates from all three categories that the user likes, and can be further aggregated into one central list for the further filtering. The candidate profiles can also display the source. In an implementation, the single view can display 1) applications from candidates; 2) recommendations of candidates; and 3) candidates discovered by review of online profiles or websites. One example is provided below:
Applications from Candidates
   Applied (via JobList+Embed)
   PROFILE (Card View)
   PROFILE (Card View)
   PROFILE (Card View)
   PROFILE (Card View)
Recommendations of Candidates (Made By People in Your Network, Or a Recommendation Algorithm)
   PROFILE (Card View)
   PROFILE (Card View)
   PROFILE (Card View)
Candidates That You Discovered By Review Online Profiles or Websites
   PROFILE (Card View)
   PROFILE (Card View)
   PROFILE (Card View)
   PROFILE (Card View)
   PROFILE (Card View)

As described above, the user can select the profiles from this single view into a list of selected candidates. For example, the user can select candidates from all three categories and the candidates are aggregated further into a list for running the search for a respective opportunity, and each candidate profile can display the source as well. One example of the list is provided below:
FAVORITES (STARRED)
   PROFILE (Card View)
      Recommended by Behance®
   PROFILE (Card View)
      Applied To Job Posting
   PROFILE (Card View)
      Referred by Matias Corea
   PROFILE (Card View)
      Discovered by You
   PROFILE (Card View)
      Referred by Matias Corea
   PROFILE (Card View)
      Discovered by You

The candidates may be selected in a variety of ways. For example, the candidates can be selected by clicking a star indicator. In another example, the user can add tags or labels to any candidates for further filtering. In a further example, the processing logic can archive the candidate profiles that are not starred or otherwise selected. Of course, additional features can be added to allow a user to select, deselect, filter, tag, or otherwise manipulate the results of the candidates to allow for talent searching.

Once selected, the profile 334 may be stored as part of the sourcing data 126. An update module 336 may then be employed by the sourcing manager module 114 to keep this sourcing data 126 “up-to-date.” For example, a profile 334 may be selected that is associated with a user that has been selected as a potential candidate for an opportunity. The update module 336 may be used to collect information about the user for inclusion as part of the profile 334 that has been created subsequent to this selection. A talent searcher, for instance, may generate a talent search on the basis of a viewing of the user's work product. Subsequent work product generated by the user may then be automatically retrieved by the update module 336 for inclusion as part of the profile 334 for that user. In this way, the sourcing data 126 may be kept up-to-date for that search as well as subsequent search for similar opportunities. The talent searcher, for instance, may have a similar opportunity at a later point in time and therefore may be able to leverage an earlier search for this later opportunity through use of the update module 336.

The candidates may also be selected on the basis of expertise as described above, which may include proficiency of the user with an application that may be involved in participation on the part of a user with the opportunity. For example, metadata 338 may be associated with the profiles 334, the metadata 338 describing the expertise of a represented candidate, an example of which is described as follows and shown in a corresponding figure.

FIG. 4 depicts a system 400 in an example implementation in which metadata describing expertise of a user is collected and used as part of a sourcing process. The system 400 includes the service provider 102 and computing device 106 of FIG. 1. Thus, the service provider 102 is configured to implement the sourcing manager module 114 and collect sourcing data 126 and the computing device 106 is representative of a potential candidate for an opportunity.

The service provider 402 is illustrated as including an application module 404 that is configured to implement an application having a plurality of functions 406 that are usable to generate a work product 408. For example, the functions 406 may relate to filters, plugins, and other functionality that may be used to process an image, sound or other media content. Other examples are also contemplated, such as publishing functions, word processing functions, spreadsheet functions, web designer functions, analytics functions, and so on. Additionally, the application may be executed locally at a computing device of a user and the metadata is exposed by including the metadata as part of a communication to be communicated to a service provider via a network. An expertise monitoring module 410 may then be used to monitor which of the functions a user has interacted with in the creation of the work product 408, such as which filters were used to process an image.

This monitoring may then be used to generate metadata 412 that describes the interaction with the functions 406 of the application module 404. The metadata 412, for instance, may be used to describe which functions 406 were used to generate the work product 408, which may then be associated with the work product 408, such as for communication as part of the work product 408. In another example, this metadata 412 may be aggregated as part of monitored creation of a plurality of different items of work product 408. For instance, this may be used to generate a listing of each function 406 a user has a history of using, which functions 406 the user has not used, to create an expertise score based on a number and collection of functions 406 used (e.g., for particular areas of functionality of the application module 404), and so on.

The expertise defined by the metadata 412 may thus be leveraged in a variety of different ways by the sourcing manager module 114 of the service provider 102. This may include use as part of a search using a post recommendation module 330 and discovery module 332, to confirm suitability of applications 202, and so on. Further, the update module 336 may also be used to keep this metadata 338 up-to-date as described above such that the sourcing data 126 may be updated with changes made by a user, such as to work product and expertise. Thus, the metadata 412 support use by a talent searcher to locate potential candidates for an opportunity. Other techniques may also be employed to obtain an accurate view of profiles as being potential candidates for an opportunity, an example of which is described as follows and shown in a corresponding figure.

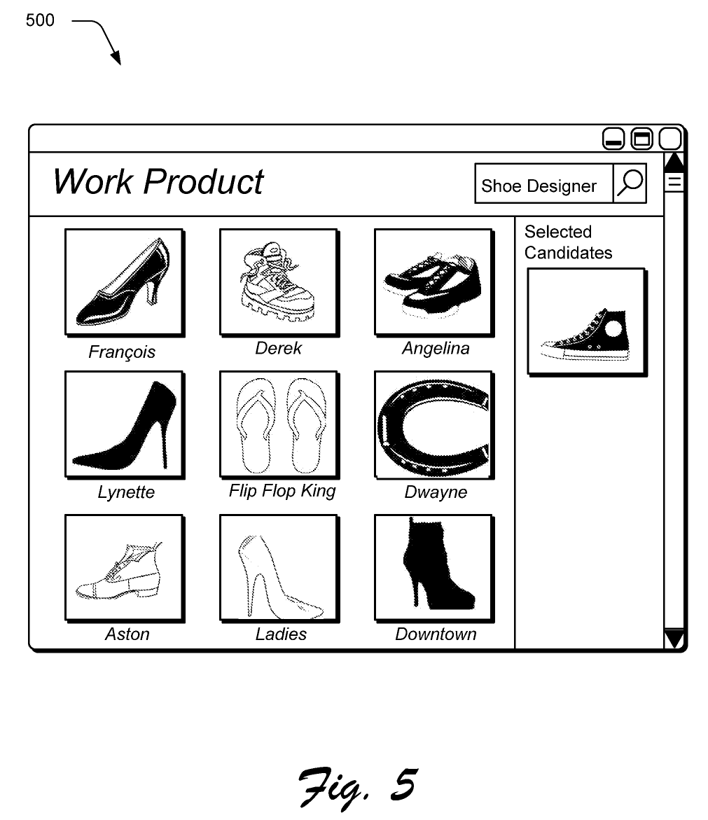

FIG. 5 depicts an example of a user interface 500 that is configured to output representations of work product as a basis to determine potential candidates for an opportunity. In this example, the user interface includes a plurality of different representations of work product. A talent searcher, for instance, may wish to locate a shoe designer and thus use functionality of the discovery module 332 to locate potential candidates. This may include using any of the other functionality as previously described.

In this example, representations of shoes designed by respective users are displayed in the user interface 500. A talent searcher may thus browse these examples of work product to locate qualities that are desired but yet may be difficult to express otherwise, such as in a keyword search. For example, in the illustrated example the talent searcher may ignore makers of women's shoes and even horse shoes in favor of sneaker designers. Thus, the work product may be used instead of a resume to represent a user. Naturally, other examples are also contemplated without departing from the spirit and scope thereof. Further discussion of these and other techniques may be found in relation to the following procedures.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

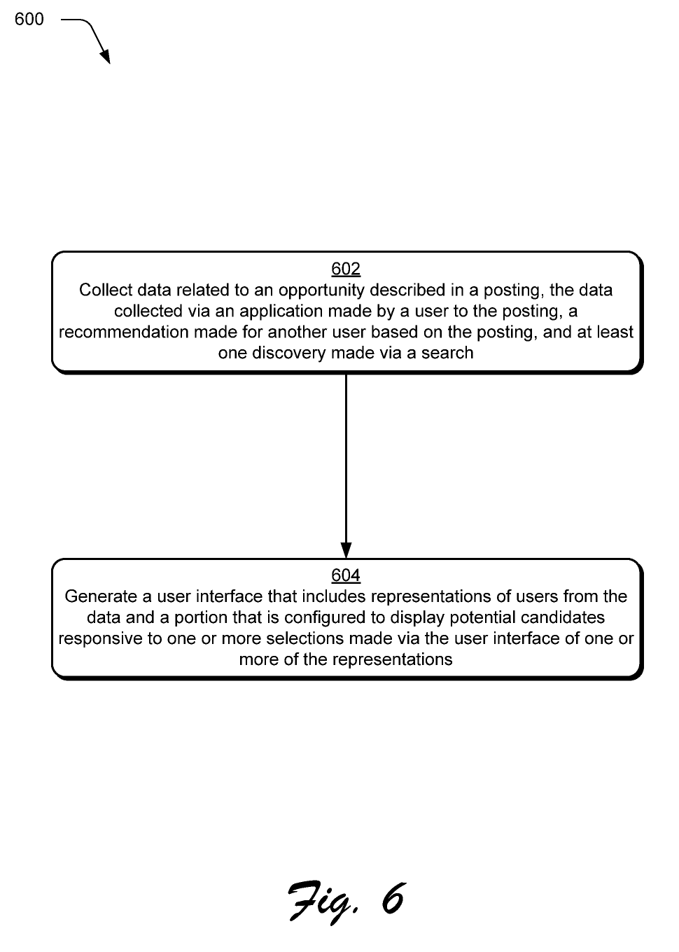

FIG. 6 depicts a procedure 600 in an example implementation in which data is collected from three sources for output in a user interface configured to support selection of potential candidates. Data is collected that is related to an opportunity described in a posting. The data is collected via an application made by a user to the posting, a recommendation made on behalf of another user based on the posting, and at least one discovery made via a search (block 602). As previously described, this collection may be performed in a variety of ways, such as through recommendations made by a user or automatically by a module, discoveries, applications, and so on.

A user interface is generated that includes representations of users from the data and a portion that is configured to display potential candidates responsive to one or more selections made via the user interface of one or more of the representations (block 604). As shown in FIG. 2, for instance, the user interface may include portions that display profiles and a portion showing potential candidates that were selected. Other examples are also contemplated, such as the example shown in FIG. 5.

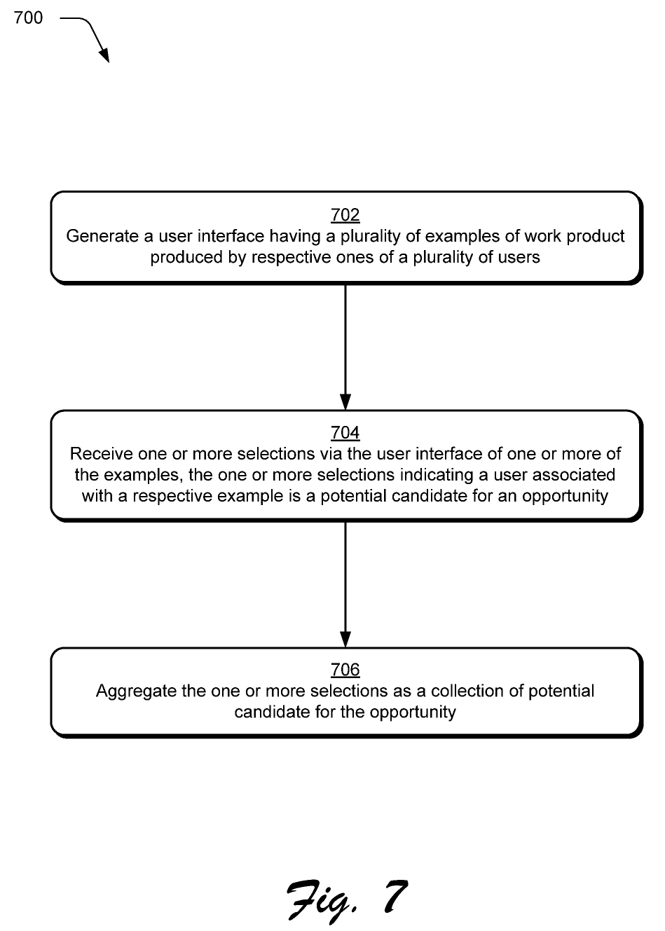

FIG. 7 depicts a procedure 700 in an example implementation in which work product is leveraged to select potential candidates for an opportunity. A user interface is generated that has a plurality of examples of work product produced by respective ones of a plurality of users (block 702). An example of this is shown in FIG. 5 but other examples are also contemplated as previously described, such as images, sound, or other media processed by a user, documents, spreadsheets, presentations, and so on created by a user, and so on. Thus, the work product may serve as a real example of a user's competence for different opportunities.

One or more selections are received via the user interface of one or more of the examples, the one or more selections indicating a user associated with a respective said example is a potential contact for an opportunity (block 704). A user interface as shown in FIGS. 2 and 5, for instance, may be used to support selection of profiles and potential candidates.

The one or more selections are aggregated as a collection of potential contacts for the opportunity (block 706). This may include display in a user interface in a dedicated portion as shown in FIG. 2, although other examples of aggregation as also contemplated, such as part of a collection of sourcing data 126 that may be accessed and kept “up-to-date” as previously described.

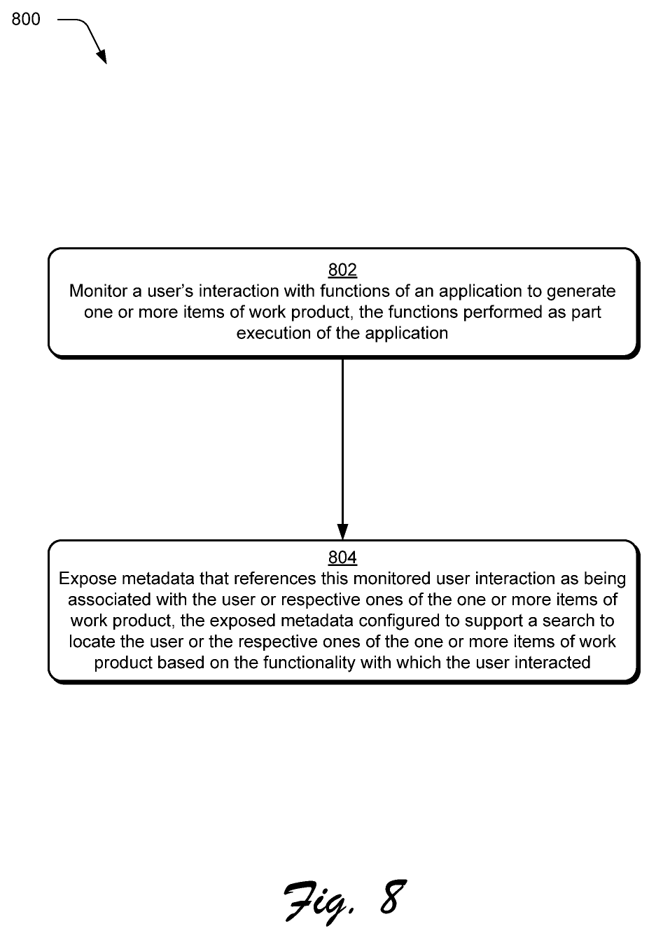

FIG. 8 depicts a procedure 800 in an example implementation in which metadata is generated that described a user's interaction with particular functions of an application. A user's interaction is monitored with functions of an application to generate one or more items of work product, the functions performed as part execution of the application (block 802). The application, for instance, may be configured to process images or sound and thus employ filters, algorithms, and other functionality.

Metadata is exposed that references this monitored user interaction as being associated with the user or respective ones of the one or more items of work product, the exposed metadata configured to support a search to locate the user or the respective ones of the one or more items of work product based on the functionality with which the user interacted (block 804). The metadata, for instance, may describe which functions have been accessed and used by the user as well as what functions have not been accessed. In this way, the metadata may not only describe what techniques were employed in the creation of a work product but also a user's expertise in creating the work product. Other examples are also contemplated as previously described.

Example System and Device

FIG. 9 illustrates an example system generally at 900 that includes an example computing device 902 that is representative of one or more computing systems and/or devices that may implement the various techniques described herein. This is illustrated through inclusion of the sourcing manager module 114, 104. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
monitoring a user's interaction with functions of an application to generate one or more items of work product, the functions performed as part execution of the application; and
exposing metadata that references this monitored user interaction as being associated with the user or respective ones of the one or more items of work product, the exposed metadata configured to support a search to locate the user or the respective ones of the one or more items of work product based on the functionality with which the user interacted.

2. A method as described in claim 1, wherein the metadata references which of a plurality of the functions of the application with which the user has interacted.

3. A method as described in claim 2, wherein the metadata does not reference at least of the functions of the application with which the user has not interacted.

4. A method as described in claim 1, wherein the application is configured to process image or sound data.

5. A method as described in claim 1, wherein the work product is an image, sound file, spreadsheet, or document.

6. A method as described in claim 1, wherein the application is accessible via a network connection from a service provider.

7. A method as described in claim 1, wherein the application is executed locally at a computing device of a user and the metadata is exposed by including the metadata as part of a communication to be communicated to a service provider via a network.

8. A method comprising:
generating a user interface having a plurality of examples of work product produced by respective ones of a plurality of users;
receiving one or more selections via the user interface of one or more of the examples, the one or more selections indicating a user associated with a respective said example is a potential candidate for an opportunity; and
aggregating the one or more selections as a collection of potential contacts for the opportunity.

9. A method as described in claim 8, wherein the opportunity relates to participation in a project or an employment opportunity.

10. A method as described in claim 8, wherein the plurality of examples of the work product include an image or sound data generated by a respective said user through interaction with an application.

11. A method as described in claim 8, further comprising updating examples of the work product for display in the user interface that corresponds to a respective said potential candidate.

12. A method as described in claim 8, wherein the work product is not a textual document.

13. A method as described in claim 8, wherein the work product is not a resume.

14. A method as described in claim 8, wherein one or more of the collection of potential candidates is viewable in the user interface concurrently with one or more of the plurality of examples of work product.

15. A method as described in claim 14, wherein at least one of the plurality of examples of work product has not been selected as a potential candidate for the opportunity.

16. A system comprising:
one or more modules implemented at least partially in hardware, the one or more modules configured to collect data related to an opportunity described in a posting, the data collected via an application made by a user to the posting, a recommendation made for another user based on the posting, and at least one discovery made via a search; and
at least one module implemented at least partially in hardware, the at least one module configured to generate a user interface that includes representations of users from the data and a portion that is configured to display potential candidates responsive to one or more selections made via the user interface of one or more of the representations.

17. A system as described in claim 16, wherein the recommendation is made for the other user by a user or generated automatically and without user intervention based on the posting.

18. A system as described in claim 16, wherein the at least one module is configured to update the user interface based on changes to the data made subsequent to the one or more selections.

19. A system as described in claim 16, wherein the search is performable using metadata that describes expertise of respective said users with an application, the metadata generated based on which of a plurality of functions of an application the respective said user has interacted with.

20. A system as described in claim 19, wherein the metadata is associated with work product generated by the respective said user through interaction with the application.
